(19) United States
(12) Patent Application Publication
(10) Pub. No.: US 2026/0042160 A1
(43) Pub. Date: Feb. 12, 2026

(54) Circular Saw Blade and Hand-Held Power Tool

(71) Applicant: Robert Bosch GmbH, Stuttgart (DE)

(72) Inventors: Massimo Tolazzi, Tavagnacco (IT); Iacopo Bodini, Udine (IT); Giorgio Treppo, Venzone UD (IT); Francesco Zampa, Pagnacco (IT)

(21) Appl. No.: 19/102,249

(22) PCT Filed: Jul. 28, 2023
(86) PCT No.: PCT/EP2023/070947

§ 371 Date: Feb. 7, 2025

(30) Foreign Application Priority Data
Aug. 15, 2022 (DE) 10 2022 208 446.2

(51) Int. Cl. B23D 61/02

(52) U.S. Cl. CPC B23D 61/026; B23D 61/028

(57) ABSTRACT

A circular saw blade has a substantially circular core zone which is surrounded by an edge zone adjoining the core zone radially outwards in the region of a boundary line in order to form a basic body. The edge zone has a plurality of teeth, each with a tooth face, and each tooth face is assigned a carbide tip. A tooth space is in each case formed between two teeth directly adjacent circumferentially, and a friction-reducing sliding coating and a wear-reducing hard coating are provided which are formed lying one above the other at least in certain regions.

### PRIOR ART

The present invention relates to a circular saw blade having a substantially circular core zone which is surrounded by an edge zone adjoining the core zone radially outwards in the region of a boundary line in order to form a basic body, wherein the edge zone has a plurality of teeth with a tooth face, and each tooth face is assigned a carbide tip, and wherein a tooth space is in each case formed between two teeth directly adjacent circumferentially. In addition, the invention relates to a hand-held power tool having such a circular saw blade.

From the prior art, a circular saw blade is known with a plurality of teeth arranged evenly spaced apart from one another circumferentially. The teeth are integrally formed in a circular basic body of the circular saw blade made of steel and fitted with a carbide tip oriented in a cutting direction to increase the service life of the circular saw blade, wherein the connection between the tooth base and the carbide tips is realized by means of a hard soldering joint in each case. The carbide platelet may comprise a coating. The coating may be single-layered or have a multi-layered structure of the same or different type. The coating may be constructed with a metal, nitride, carbide, carbonitride, oxide, or oxynitride each containing one or more elements such as chromium, titanium, and aluminum.

### DISCLOSURE OF THE INVENTION

The invention relates to a circular saw blade having a substantially circular core zone which is surrounded by an edge zone adjoining the core zone radially outwards in the region of a boundary line in order to form a basic body, wherein the edge zone has a plurality of teeth with a tooth face, and each tooth face is assigned a carbide tip, and wherein a tooth space is in each case formed between two teeth directly adjacent circumferentially. The circular saw blade comprises a friction-reducing sliding coating and a wear-reducing hard coating, which are formed lying one above the other at least in certain regions.

The sliding coating allows significant reduction in friction between the circular saw blade and a part to be machined, while the hard coating reduces wear and tear on the circular saw blade. The combination of the two types of coating results in a synergy effect, which makes it possible to increase the service life of a coated circular saw blade according to the invention by a factor of up to 3 compared to a circular saw blade provided only with a sliding coating. A radial width of the circular edge zone is in a range between 10% and 30%, preferably 20%, in relation to the radius of the circular saw blade. The radius of the circular saw blade is defined between its longitudinal central axis in the region of the fastening opening and a tooth circumference. The cutting process of a part to be machined primarily takes place in the region of the edge zone, while the core zone is intended, among other things, for guiding the circular saw blade in the cutting kerf of the part to be machined and for connection to the output shaft of a drive motor.

In general, it is advantageous to first provide the metallic saw blade with the hard coating and then form the sliding coating.

Preferably, the core zone is provided with the sliding coating and the edge zone with the hard coating and the sliding coating.

As a result, substantially only highly stressed regions of the circular saw blade are provided with the more cost-intensive hard coating. A boundary line resulting between the hard coating and sliding coating can have a geometry that deviates from a circular profile and can be formed, for example, undulating, triangular or trapezoidal, meandering, etc.

In the case of another embodiment, the core zone is provided with the sliding coating and the edge zone is provided with the hard coating and the sliding coating, wherein the carbide tips are provided exclusively with the hard coating at least in certain regions.

Due to the combination of properties of sliding coating and hard coating in the edge zone, further optimization of the sawing behavior of the saw blade is possible.

In another embodiment, the core zone is provided with the sliding coating only, and the edge zone with the hard coating and the sliding coating adjoins it radially outwards, wherein the teeth are provided exclusively with the hard coating, and the hard coating thereof extends radially inwards up to a preferably circular transition line extending within the edge zone, wherein the transition line extends radially outwards, inwards or coincides with a tooth base circle of the teeth.

As a result, the teeth and radially inward regions of the circular saw blade are wear-resistant.

According to a further embodiment, starting from at least two preferably diametrically arranged teeth, the circular saw blade in the edge zone comprises a substantially V-shaped and radially inward directed slot free of coating.

The open slots on one side can reduce any tendency for the circular saw blade to vibrate and the noise it makes. The term “slot free of coating” defines here that the opposing slot walls, the height of which corresponds to a material thickness of the basic body of the circular saw blade, do not have a sliding coating or hard coating.

Preferably, at least two approximately V-shaped circumferential slots are provided in the edge zone, which are substantially oriented in a circumferential direction and are free of coating and preferably located in the edge zone.

The sawing behavior can be further improved due to the circumferential slots introduced on both sides within the basic body. The circumferential slots are preferably evenly spaced from one another on the circumferential side and are each cut at the same radial distance from the longitudinal center axis.

In the case of another embodiment, it is provided that at least two slot assemblies free of coating are provided in the core zone.

This can, among other things, reduce the noise produced during sawing. In addition, the required drive power of the circular saw blade is reduced as this may perform at least minor lateral evasive movements. Moreover, the clamping tendency and wear due to abrasion in the region of the saw kerf may decrease.

Preferably, the at least two slot arrangements each have an approximately V-shaped circumferential slot, the longer portion of which is substantially in the circumferential direction and the shorter leg of which is inclined radially outward relative to the circumferential direction, wherein a shorter slot is formed on the longer portion.

This provides the circular saw blade with further movement options transverse to the basic body.

In accordance with an advantageous embodiment, the core zone of the circular saw blade comprises a fastening opening for a drive shaft and the fastening opening is arranged centrically to a longitudinal center axis of the circular saw blade.

This provides a robust mechanical coupling to a drive shaft of a drive motor.

Preferably, the core zone and the edge zone of the basic body are integral with a hardened steel and the carbide tips are preferably formed with a tungsten carbide-cobalt carbide.

This means that commonly available standard materials are available for the manufacture of the circular saw blade. The integral basic body of the circular saw blade is preferably separated from a plate-shaped metallic semi-finished product by laser beam cutting. Alternatively, manufacturing using known punching methods is also possible.

Preferably, the carbide tips are fixedly connected to the assigned tooth face, in particular thermally joined thereto.

This provides a reliable and mechanically highly resilient connection between the carbide tips forming the actual cutting edges, and the individual teeth of the circular saw blade. The sliding coating is preferably a lubrication coating and has the function of reducing the friction between the circular saw blade and the resinification and heat generation. It also protects the circular saw blade from oxidation and rust. The sliding function may be achieved by adding lubricant fillers (e.g., Teflon, graphite, oxide, etc.) to the coating formulation. The sliding coating may be applied by a spray coating process or other known technologies. The hard coating preferably has a higher hardness than the basic body of the circular saw blade and is preferably formed in the edge zone. The hard coating may be made of chromium-aluminum (AlCrN), zirconium (ZrN) or carbon nitrates with titanium (TiN and TiCN), titanium-aluminum (TiAlN and TiAlCN), titanium-silicon (TiSiN and TiSiCN), and/or other combinations thereof. The function of the hard coating is to reduce wear on the teeth and thereby prolong the service life of the circular saw blade. The hard coating may be produced by physical or chemical deposition within a vapor phase using known methods. The geometrical zones with the two different coatings can be realized with the aid of templates/masks in the coating process, for example.

Moreover, the invention relates to a hand-held power tool, in particular a hand-held circular saw or table circular saw, having a circular saw blade described above. Furthermore, the circular saw blade described above could also be employed in a stationary machine.

As a result, a hand-held power tool is available with a significantly longer service life without the need to change tools.

### BRIEF DESCRIPTION OF THE DRAWINGS

The invention is explained in more detail in the following description with reference to the embodiment examples shown in the drawings. The figures show:

FIG. 1 a schematic view of a first embodiment of a circular saw blade,

FIG. 2 a schematic view of a second embodiment of a circular saw blade,

FIG. 3 a schematic view of a third embodiment of a circular saw blade,

FIG. 4 a schematic view of a fourth embodiment of a circular saw blade with slots in the edge zone,

FIG. 5 a schematic view of a fifth embodiment of a circular saw blade with slots in the core zone, and

FIG. 6 a diagram of the service life of a circular saw blade according to the invention.

### DESCRIPTION OF THE EMBODIMENT EXAMPLES

In the drawings, essentially identical elements having the same or comparable function are consistently assigned the same reference characters for the sake of drawing efficiency and are only described once in greater detail.

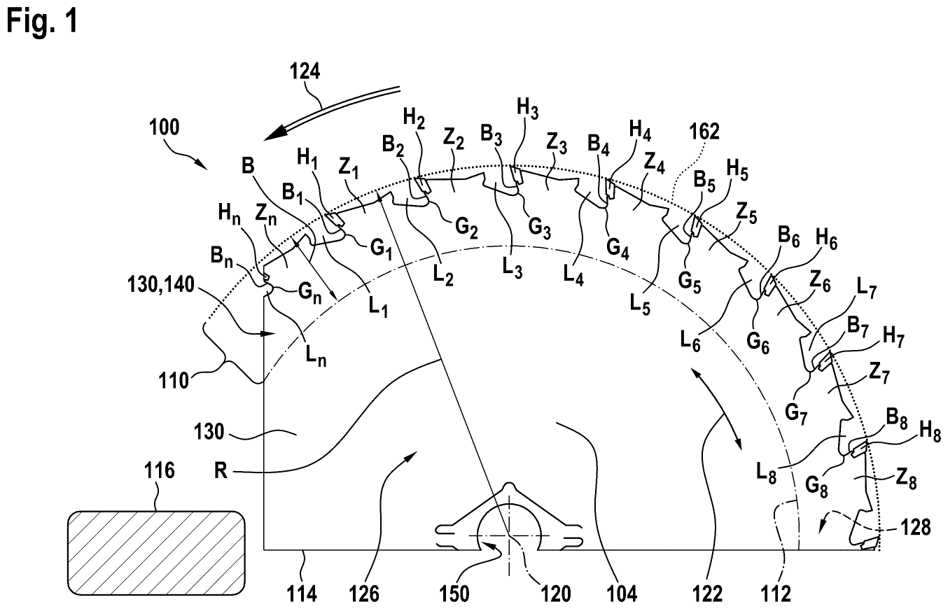

FIG. 1 shows a circular saw blade 100, which is only partially drawn for better graphical representation, which has a substantially circular core zone 104, which is coaxially surrounded by a circular edge zone 110 which adjoins the core zone 104 radially outwards in the region of a circumferential boundary line 112, forming an approximately disk-shaped basic body 114 with a radius R. The circular saw blade 100 is preferably symmetrical rotationally towards a longitudinal center axis 120 and has a central fastening opening 150 for rotationally connecting to an output shaft of a hand-held power tool or stationary machine not shown in the drawings. The core zone 104 extends radially outward from the fastening opening 150 to the boundary line 112 from which the edge zone 110 begins with a toothing.

The core zone 104 and the edge zone 110 together form the integral disk-shaped basic body 114 of the circular saw blade 100. The disk-shaped basic body 114 is manufactured with a hardened steel and has only a small material thickness compared to the magnitude of the radius R, so that a sufficiently narrow saw cut in the part 116 can be achieved with a sufficiently high stiffness of the circular saw blade 100. The circular edge zone 110 has an approximately radial width B, which is in a range between 10% to 30%, preferably 20% of the radius R of the circular saw blade 100 and a tooth circumference 162.

The edge zone 110 comprises a plurality of similar (saw) teeth Z_{1, . . . n} directed radially outward each having a tooth face B_{1, . . . n}. The tooth faces B_{1, . . . n} are each directed towards a part 116 to be machined or sawn, with a corresponding further rotation of the circular saw blade 100 in a cutting direction 124. The teeth Z_{1, . . . n} of the circular saw 100 are arranged in a circumferential direction 122 preferably evenly spaced apart from each other, with a tooth space L_{1, . . . n} of the same width L_{1, . . . n} with a tooth base G_{1, . . . n} between each of the circumferentially directly adjacent teeth. The tooth bases G_{1, . . . n} each represent a lowest lying region of each tooth space L_{1, . . . n} in a radially inward direction. Each tooth face B_{1, . . . n} of a Z_{1, . . . n} tooth is preferably assigned a carbide tip H_{1, . . . n} to increase the cutting efficiency of the saw blade 100. The carbide tips H_{1, . . . n} are preferably realized with a tungsten carbide-cobalt carbide or a material of comparable or even greater hardness. The carbide tips H_{1, . . . n} are fixedly connected to the respective teeth Z_{1, . . . n} assigned to them in the region of the respective tooth face B_{1, . . . n} tooth, preferably thermally joined to them.

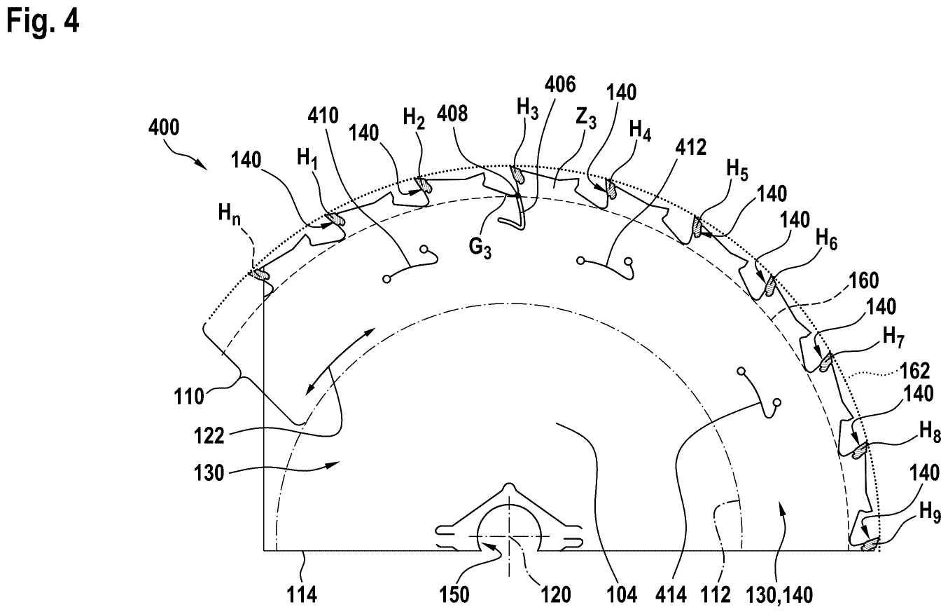

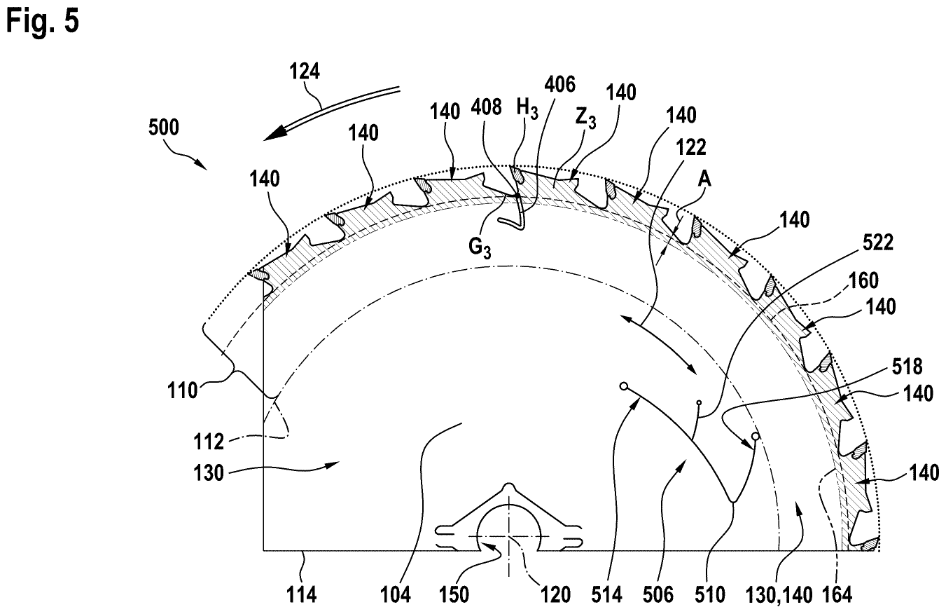

The circular saw blade 100, shown here as an example, and all further embodiments of circular saw blades according to the invention discussed below, preferably have an identical geometry in each case-apart from an optional slotting (see FIG. 4 and FIG. 5)—and are only provided with a sliding coating 130 and/or a hard coating 140 in different surface areas. According to the present invention, the circular saw blade 100 and all further embodiments of coated circular saw blades explained in the further course of the description in the region of a front side 126 and a hidden rear side 128 each comprise a friction-reducing sliding layer 130 and a wear-reducing hard coating 140, which are at least partially overlying or overlapping with each other. In the first embodiment of the circular saw blade 100 illustrated herein, the core zone 104 is provided with the sliding coating 140 and the edge zone 110 is provided with the hard coating 140 and the sliding coating 130, with full inclusion of the teeth Z_{1, . . . n}, wherein the sliding coating 130 is preferably formed on the hard coating 140 already produced underneath.

The sliding coating 130 is preferably a lubrication coating and is primarily used to reduce friction and wear, as well as to reduce the frictional heat generated in the saw cut. As a result, resinification and crumbling of chips in the region of the saw cut is avoided. The sliding function may be achieved by adding lubricant fillers (e.g., Teflon, graphite, oxide, etc.) to the actual coating formulation. For example, the coating formulation may be realized with high temperature plastic materials as a binder. For example, the sliding coating 130 may be applied to the basic body 114 of the corresponding pre-masked circular saw blade 100 and/or to the hard coating 140 by means of known spraying methods.

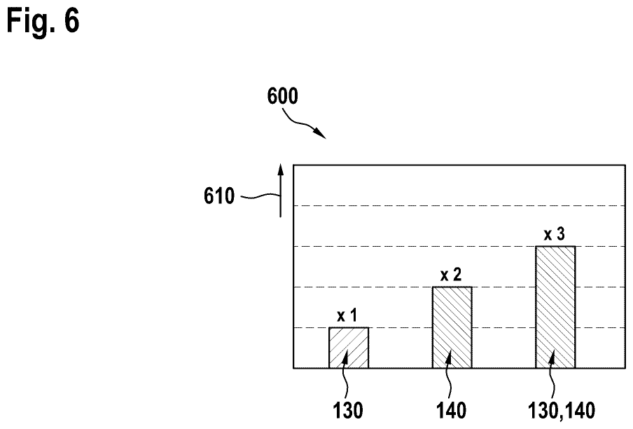

The hard coating 140 may be formed with nitrates of chromium-aluminum (AlCrN), zirconium (ZrN) or carbon nitrates of titanium (TiN and TiCN), titanium-aluminum (TiAlN and TiAlCN), titanium-silicon (TiSiN and TiSiCN), and/or other combinations. Due to the sliding coating and hard coating 130, 140 present here in the edge zone 110, there is a considerable increase in the service life of the circular saw blade 100 (see in particular FIG. 6).

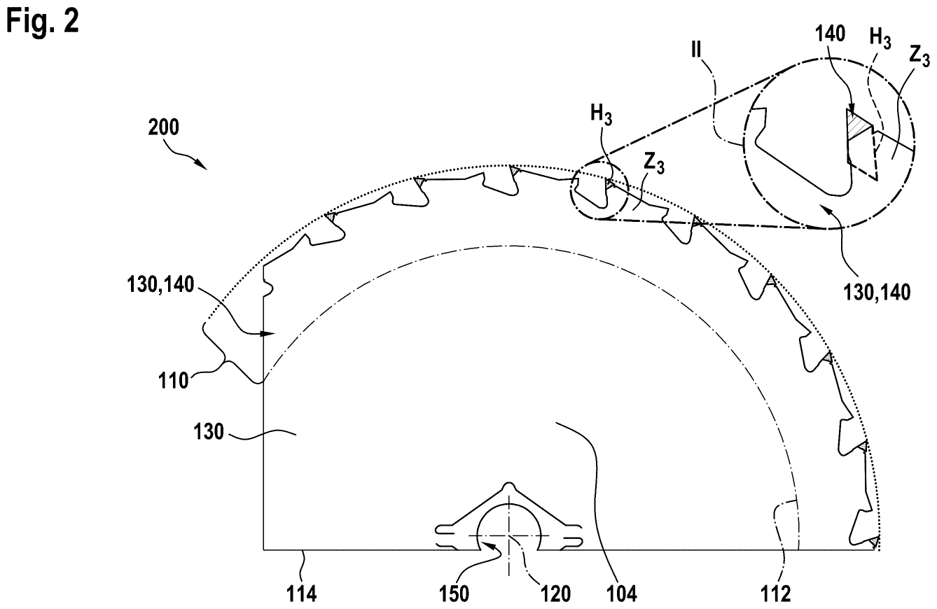

FIG. 2 shows a circular saw blade 200, which illustratively corresponds geometrically to the circular saw blade 100 of FIG. 1 and accordingly comprises the core zone 104 with the radially adjacent edge zone 110, which is separated from the core zone by the boundary line 112. The core zone 104 and the edge zone 110 form the basic body 114 of the circular saw blade 200 with the fastening opening 150. The basic body 114 is arranged rotationally symmetrically to the longitudinal center axis 120. The edge zone 110 has the (saw) teeth, wherein only one tooth Z₃ is designated here as representative of all the other teeth for the sake of a better overview of the drawings.

The core zone 104 is also provided with the sliding coating 130 and the edge zone is provided with the hard coating 140 and the sliding coating 130, wherein unlike the circular saw blade 100 of FIG. 1, the carbide tip H₃ of the tooth Z₃ is provided exclusively with the hard coating 140 at least in certain regions, as shown in the section enlargement II. The same applies to the remaining teeth not designated and shown herein and their assigned carbide tips.

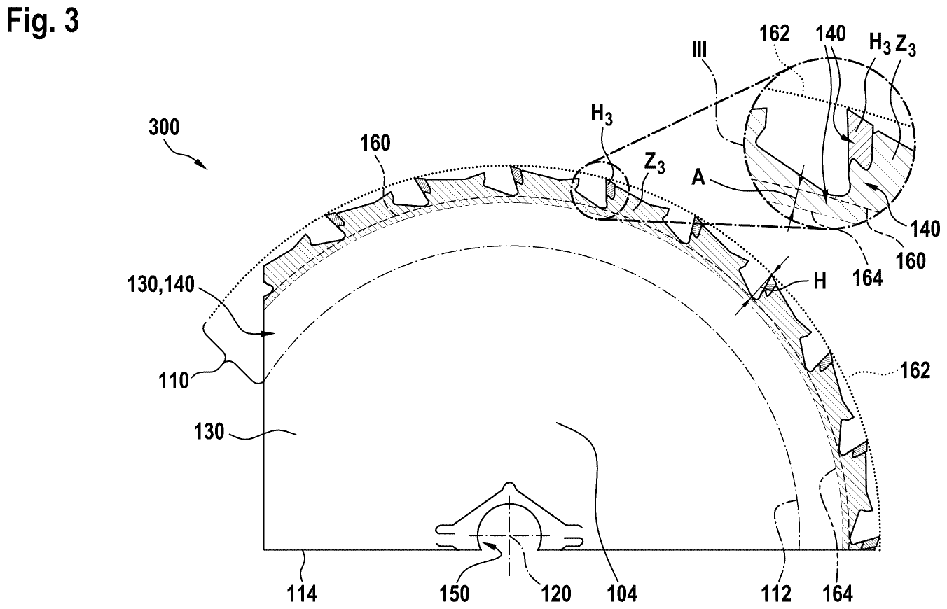

FIG. 3 shows a circular saw blade 300, which also illustratively corresponds to the circular saw blade 100 of FIG. 1, and to the circular saw blade 200 of FIG. 2, and thus has the basic body 114 with the core zone 104 and the edge zone 110, which are separated by the boundary line 112. The basic body 114 has the fastening opening 150 formed centrally to the longitudinal center axis 120. The core zone 104, in turn, is exclusively provided with the sliding coating 130. The edge zone 110 with the hard coating 140 and the sliding coating 130 adjoins it radially outward.

In contrast to FIG. 1 and FIG. 2, the tooth Z₃ and all further unnamed teeth are only provided with the hard coating 140, which extends radially inwards up to an approximately circular transition line 164 that extends within the edge zone 110. This transition line 164 can run radially outwards, in relation to a tooth base circle 160 of the teeth, inwards-as shown here as an example—or coincide with it. The tooth base circle 160 coincides with the radially inward lowest regions of the tooth bases of the teeth spaces between the teeth.

It can be seen in the section enlargement III that the tooth Z₃ and its carbide tips H₃ are provided exclusively with the hard coating 140 radially inwards up to the transition line 164. The same applies to all remaining unnamed teeth.

A radial distance A between the transition line 164 and the tooth base circle 160 is preferably between the value zero and the amount of the tooth height, which is defined herein as a radial distance H between the tooth circle 162 and the tooth base circle 160.

FIG. 4 shows a circular saw blade 400 which also illustratively corresponds geometrically to the circular saw blade 100 of FIG. 1, and the circular saw blade 200 of FIG. 2 and the circular saw blade 300 of FIG. 3, and accordingly has the basic body 114 consisting of the core zone 104 with the fastening opening 150 designed centrally to the longitudinal central axis 120 and the edge zone 110 with the teeth, separated by means of the boundary line 112, of which only the tooth Z₃ is designated here. The core zone 104 is provided exclusively with the sliding coating 130, whereas the edge zone 110—except for the carbide tip Hn, . . . , 9 and all other unmarked carbide tips—are provided with the sliding coating and the hard coating 130, 140. Only the carbide coating 140 is formed at the Hn . . . 9 carbide tip.

In contrast to the previous embodiments, the circular saw blade 400 now has an approximately V-shaped and radially inwardly directed slot 406 free of coating in the edge zone 110 of the basic body 114, starting from the tooth base G₃. In order to avoid an imbalance of the saw blade 400, another slot not shown herein is provided diametrically to the slot 406. Accordingly, further slots may be provided in the range of two opposing tooth bases of the teeth while taking into account the rotational symmetry to prevent imbalance. In principle, any even number of slots between two and the total number of teeth is possible.

The slots each assume a “lowest” point of the respective tooth bases in the area of the tooth base circle 160, which lies radially inwards the farthest and of which only one point 408 is designated here for the sake of a better graphical overview. The slots or their opposing walls are each free of any coating, i.e., neither the sliding coating nor the hard coating 130, 140, so as not to interfere with any lateral movements of the saw blade 400 parallel to the longitudinal center axis 120. These lateral evasive movements of the saw blade 400 help reduce vibration and noise, among other things, and reduce the risk of jamming of the saw blade 400 in the saw cut.

In addition, the saw blade 400 in the edge zone 110 of the basic body 114 has, by way of example here, at least two circumferential slots which are substantially oriented in the circumferential direction 122 and are also free of coating, of which only three circumferential slots 410, 412, 414 are shown here as representative of all the others. The circumferential slots 410, 412, 414 are preferably introduced in the circumferential direction 122 evenly spaced apart from each other and with equal radial distance to the longitudinal center axis 120 into the basic body 114 of the saw blade 400. Preferably, each circumferential slot 410, 412, 414 has a bore, which is not designated for the sake of a better graphical overview, on the end side to avoid mechanical stresses in the basic body 114 of the saw blade 400. The circumferential slots 410, 412, 414 allows a further improvement of the sawing behavior, that is to say a particularly smooth cutting behavior of the circular saw blade 400, to be achieved.

All slots or circumferential slots 410, 412, 414 completely penetrate the basic body 114 of the saw blade 400 in the axial direction and parallel to the longitudinal center axis 120. The circumferential slots 410, 412, 414 may also be provided at least in part in the core zone 104 or extend radially inward from the edge zone 110 into the core zone 104.

FIG. 5 shows a circular saw blade 500 also arranged geometrically corresponding to the circular saw blade 100 of FIG. 1, and to the circular saw blade 200 of FIG. 2, the circular saw blade 300 of FIG. 3, and the circular saw blade 400 of FIG. 4, and thus also comprises the core zone 104 with the edge zone 110 separated from the boundary line 112. To rotate the circular saw blade 500 in the cutting direction 124, the fastening opening 150 is provided centrically to the longitudinal center axis 120 of the circular saw blade 500. The teeth, of which only the tooth Z₃ is designated, are evenly spaced apart from one another in the circumferential direction 122 and are directed radially outwardly within the edge zone 110. As with FIG. 4, the slot 408 free of coating is provided, which again extends radially inwards up to the edge zone 110 starting from the tooth base circle 160 or the lowest point of the tooth base G₃. The core zone 104 again has the sliding coating 130, while the edge zone is provided with the hard coating 140 and the sliding coating 130 radially outwards up to the transition line 164. The teeth, including their carbide tips, are in turn treated radially inwards up to the transition line 164 exclusively with the hard coating 140, wherein the transition line 164 runs at the radial distance A in relation to the tooth base circle 160 (also see FIG. 3).

In contrast to the embodiments discussed above, the basic body 114 of the circular saw blade 500 now comprises at least two additional diametrically positioned slot assemblies free of coating that lie within the core zone 104. Of the at least two slot assemblies, only one slot assembly 506 is representative of all the others. The slot assembly 506 has an approximately V-shaped circumferential slot 510 with a longer portion 514 oriented substantially in the circumferential direction 122 and with a shorter portion 518 that is inclined radially outwardly relative to the circumferential direction 122. Between the longer portion 514 and the shorter portion 518 of the circumferential slot 510, there is an angle a on the order of, for example, 60°. A slot 522 that is approximately parallel to the shorter portion 518 of the circumferential slot 510, and preferably shorter than it, is also provided at the longer portion 514.

Due to the slot arrangement 506 and all slot arrangements not shown, further lateral possibilities of movement of the circular saw blade 500 with respect to the drawing plane or parallel to the longitudinal center axis 120 are created.

FIG. 6 shows a diagram 600 illustrating a service life of a circular saw blade according to the embodiments described in FIG. 1 through FIG. 5. Along the abscises of the diagram 600, three columns are applied with different types of coatings of a circular saw blade, while the ordinates illustrate an achievable service life 610 of the circular saw blade.

The left column represents the exclusive sliding coating 130, the center column represents the exclusive hard coating 140, while the right column represents the combined sliding coating and-hard coating 130, 140 of the saw blade. The sliding coating 130 doubles the service life of the circular saw blade equipped in this way compared to an untreated circular saw blade.

In view of the fact that the hard coating 140 and the sliding coating 130 are overlaid or combined at least in certain regions, according to the invention a tripling of the service life in relation to an untreated circular saw blade can be achieved under favorable circumstances.

In addition, the invention relates to a hand-held power tool, such as a hand-held, table or cross-cut circular saw, which is equipped with a circular saw blade in one of the embodiments discussed above in order to increase the service life of the circular saw blade by a factor of up to three compared to conventional circular saw blades.

1. A circular saw blade comprising:
a substantially circular core zone;
an edge zone surrounding the core zone and adjoining the core zone radially outwards in a region of a boundary line so as to form a basic body
wherein the edge zone has a plurality of teeth, each of which has tooth face, and each tooth face is assigned a carbide tip,
wherein a tooth space is in each case formed between two teeth directly adjacent circumferentially, and
wherein the circular saw blade includes a friction-reducing sliding coating and a wear-reducing hard coating, which are formed lying one above the other at least in certain regions.

2. The circular saw blade according to claim 1, wherein the core zone is provided with the sliding coating and the edge zone is provided with the hard coating and the sliding coating.

3. The circular saw blade according to claim 1, wherein the core zone is provided with the sliding coating and the edge zone is provided with the hard coating and the sliding coating wherein the carbide tips are provided exclusively with the hard coating at least in certain regions.

4. The circular saw blade of claim 1, wherein:
the core zone is provided with the sliding coating only,
a region of the edge zone radially adjoining the core zone includes both the hard coating and the sliding coating,
the teeth are provided exclusively with the hard coating and the hard coating extending radially inwardly from the teeth to a transition line extending within the edge zone and the transition line extends radially outwards, inwards or coincides with a tooth base circle of the teeth.

5. The circular saw blade according to claim 1, wherein the circular saw blade comprises in the edge zone starting from at least two diametrically arranged tooth bases in each case a substantially V-shaped and radially inwardly directed slot free of coating.

6. The circular saw blade according to claim 5, wherein at least two approximately V-shaped slots are provided in the edge zone which are oriented substantially in a circumferential direction and are free of coating and located in the edge zone.

7. The circular saw blade according to claim 5, wherein at least two slot arrangements free of coating are provided in the core zone

8. The circular saw blade according to claim 7, wherein:
each of the at least two slot arrangements includes an approximately V-shaped circumferential slot longer portion of which runs substantially in the circumferential direction and a shorter portion of which is inclined radially outwardly relative to the circumferential direction, and
a shorter slot is formed on the longer portion

9. The circular saw blade according to claim 1, wherein the core zone of the circular saw blade comprises a fastening opening for a drive shaft, and the fastening opening is arranged centrically to a longitudinal center axis of the circular saw blade.

10. The circular saw blade according to claim 1, wherein the core zone and the edge zone of the basic body are formed integrally with a hardened steel, and the carbide tips are formed with a tungsten carbide-cobalt carbide.

11. The circular saw blade according to claim 1, wherein the carbide tips are fixedly connected to the respective assigned tooth face.

12. A hand-held power tool, comprising:
the circular saw blade according to claim 1.

13. The circular saw blade according to claim 1, wherein the transition line is circular.

14. The hand-held power tool according to claim 12, wherein the hand-held power tool is a hand saw, a table saw, or a circular saw.
